(19) United States
(12) Patent Application Publication
(10) Pub. No.: US 2016/0101011 A1
(43) Pub. Date: Apr. 14, 2016

(54) Neck exercise and rehabilitation device

(71) Applicant: Ryan Swenson, Rapid City, SD (US)

(72) Inventor: Ryan Swenson, Rapid City, SD (US)

(21) Appl. No.: 14/121,697

(22) Filed: Oct. 8, 2014

(51) Int. Cl. A61H 1/02

(52) U.S. Cl. CPC A61H 1/0296; A61H 2001/0207; A61H 2205/04

(57) ABSTRACT

A neck exercise and rehabilitation device is disclosed which may be removably affixed to a user's head and a weight within the device rotates in a plane perpendicular to a vertical axis through a user, and the user's body reacts to counteract the changing position of the moving weight which acts to strengthen and rehabilitate the user's back and spine.

### BACKGROUND OF THE INVENTION

1. Field of the Invention

The present invention relates generally to devices which aid in rehabilitation of a person and more specifically to a neck exercise and rehabilitation device which may be used to strengthen and exercise the muscles of the neck.

2. Background Information

Throughout history, people have been suffering injury or weakness to the spine, including the neck. For many years people have also been inventing devices to exercise or rehabilitate a weak or injured neck. Most neck and spine experts agree that the best way to rehabilitate and weak or injured neck, is through exercise and movement.

The patent to Taimela (U.S. Pat. No. 6,551,214; Apr. 22, 2003) discloses a device which is fairly typical of a common type of device used to exercise the muscles around the cervical spine. This device includes a head rest element in which the head is held substantially immobile. The head rest element is connected to a turning arbor which rotates about a vertical axis. Thus, the head is forced by the arbor to turn from side to side and slightly downward. Another type of device used for neck therapy exercise is disclosed in the patent to Brooks (U.S. Pat. No. 6,106,437; Aug. 22, 2000). In Brooks, the user sits on a bench with the head at the level of a circular ring. The head fits within a helmet and it is possible to hook the helmet at various locations to a weight which hangs from a pulley on the ring. Exercises may then be done working against the resistance supplied by the weights. Other known neck exercise and rehabilitation devices may be as simple as an elastic strap which is put around one side of the head and pulled in a particular direction to provide resistance for exercise. Prior art neck rehabilitation or exercise devices such as those shown in Taimela and Brooks are complicated and heavy. Other prior art neck rehabilitation or exercise devices do not provide sufficient adjustment or control

The neck exercise and rehabilitation device of the instant invention solves the above problems by providing a device which may be used to rehabilitate or exercise the cervical spine. The instant invention is adjustable to provide for a variety of rehabilitation or exercise settings. The device is also simple, light weight, reliable, inexpensive, and easy to operate and maintain.

### SUMMARY OF THE INVENTION

The neck exercise and rehabilitation device of the instant invention includes headgear which a user may affix to the head. A weight is slideably affixed to a rod on the top of the headgear. The rod rotates about a pin which is affixed to the top of the headgear and which is centered upon a vertical axis which passes through a user's head. That is, the weight rotates in a plane which is perpendicular to the vertical axis of the user's head and about a point which is directly above the user's head. As the weight moves about a user's head, it tends to unbalance the user's head toward the direction of the weight. The user automatically uses neck muscles to move the head to counteract the mass of the offset weight. Thus, the user automatically exercises all the muscles of the neck by working against the resistance of the weight in 360 degrees of arc.

The rotation of the weight is powered by an electric motor and the speed at which the weight rotates may be controlled by controlling the electric motor. The distance from the weight to the central pin may also be controlled. As may be seen, when the weight is closer to the central pin, less effort is required of the neck muscles to counteract the weight than when the weight is further from the central pin. The effect of the weight upon the user may be adjusted both by changing the speed of rotation of the weight and the distance of the weight from the center of rotation. Also a different sized weight may be used.

One of the major objects of the present invention is to provide a device which may be used to rehabilitate or exercise the cervical spine.

Another objective of the present invention is to provide a neck rehabilitation or exercise device which is adjustable to provide for a variety of rehabilitation or exercise settings.

Another objective of the present invention is to provide a neck exercise and rehabilitation device which is simple, light weight, reliable, inexpensive, and easy to operate and maintain.

These and other features of the invention will become apparent when taken in consideration with the following detailed description and the drawings.

### BRIEF DESCRIPTION OF THE DRAWINGS

FIG. 1 is a side view of the preferred embodiment of the neck exercise and rehabilitation device of the instant invention;

FIG. 2 is a rear view of the instant invention; and

FIG. 3 is a side view of a second embodiment of the instant invention.

### DESCRIPTION OF A PREFERRED EMBODIMENT

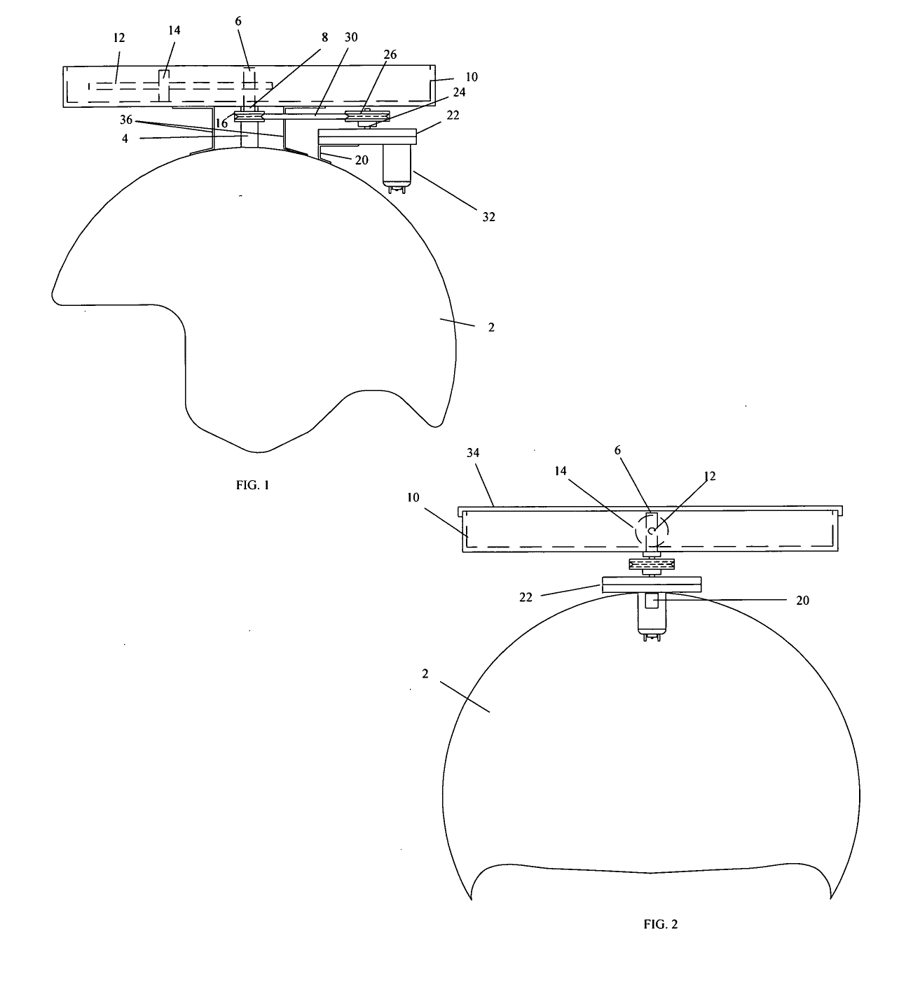

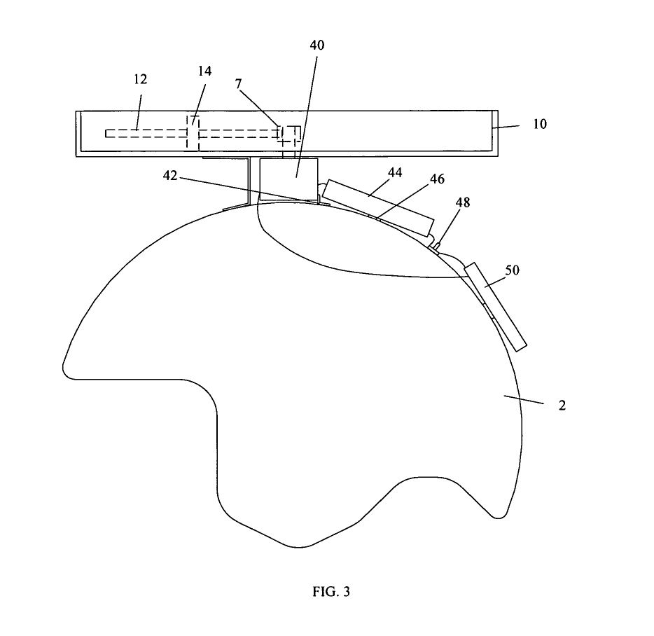

Referring to the drawings, FIGS. 1 and 2 there is shown a preferred embodiment of the instant invention. FIG. 3 shows a second embodiment of the instant invention.

Now referring to FIG. 1, a side view of a neck exercise and rehabilitation device implementing the instant invention is shown. A helmet 2 is provided which may be any conventional helmet such as a football helmet or any other type of head gear which may be securely affixed. Helmet 2 is of a type which may be secured to a user's head in a conventional manner. As may be seen, headgear different than a helmet may be used, provided the instant invention may be affixed to the headgear near the top of the headgear. A stud 4 is affixed to the top of said helmet 2 such that it is aligned with a vertical axis through a user. A pin 6 is rotatably affixed to the top of the stud 4 such that the pin 6 may rotate around a vertical axis through a user. A plate 8 has the general shape of an hollow cylinder and is affixed to the underside of the center of a pan 10. Said pin 6 fits within the plate 8 and rotates inside said plate 8. The pan 10 is round and has the shape of a short cylinder with a closed bottom and an open top. The center of said pan 10 is aligned with the center of said pin 6.

Still referring to FIG. 1, a rod 12 is affixed at one end to said pin 6. A weight 14 is affixed to the rod 12 at a point between the end of said rod 12 affixed to said pin 6 and the other end of said rod 12. Said rod 12 is perpendicular to said pin 6. Said rod 12 and said weight 14 fit within said pan 10. A small pulley 16 is affixed to said pin 6 between said plate 8 and said stud 4. A power bracket 20 is affixed to the top surface of said helmet 2 on the top surface of said helmet 2. A gear box 22 is affixed to the power bracket 20. A drive pin 24 protrudes from the top of the gear box 22. A large pulley 26 is affixed to the drive pin 24. The large pulley 26 is affixed to said small pulley 16 by means of a belt 30. An electric motor 32 is affixed to said gear box 22. The electric motor 32 is engaged to a gear within said gear box 22 and this gear engages said drive pin 24. Thus when said electric motor 32 is turned on, it engages said drive pin 24 by means of gears and acts to spin said drive pin 24. Using said belt 30, said drive pin 24 acts to turn said pin 6. When said pin 6 turns, said rod 12 and said weight 14 spin within said pan 10. Said electric motor 32 may be powered by plugging it into a conventional AC electric socket. The instant invention could also be easily adapted to operate using a battery rather than plugging the device into an AC socket. In the preferred embodiment, said electric motor 32, said gear box 22, and said drive pin 24 were purchased as a single unit. The single unit is a “gearmotor” available from McMaster-Carr (P.O. Box 4355, Chicago, Ill. 60680-4355; 630-833-0300.) The gearmotor is rated at 25 rpm, 20 in-lbs torque and 1.3 full amps load.

Still referring to FIG. 1, said electric motor 32 is connected to a conventional rheostat (not shown) which controls the speed and direction of said electric motor 32. Thus, in this configuration, said electric motor 32 may be used to cause said weight 14 to rotate about said pin 6 in either direction and at any speed from 0 to 125 rpm. That is, said electric motor 32 turns said drive pin 24 and said drive pin 24 and said belt 30, act to turn said pin 6 which turns said rod 12 and said weight 14. A pair of clips 36 are used to affix said pan 10 to said helmet 2 such that said pan 10 is roughly horizontal when said helmet 2 is in use.

Referring now to FIG. 2, a rear view of the instant invention is shown. This view, perhaps, better shows the alignment and relative position of the various elements. This view shows that said weight 14 is centered upon said rod 12. In the preferred embodiment said weight 14 weighed 2 ounces but the purpose and function of the instant invention could be served as well with said weight 14 having a different weight. In testing, weights weighing from 5 ounces to twelve ounces were used. This view also shows a lid 34 which may be removably affixed to the top of said pan 10.

Now referring to FIG. 3, a second embodiment of the instant invention is shown. In the previously described embodiment, said electric motor 32 turns said drive pin 24 and said belt 30 to turn said pin 6. In this embodiment a stepper motor (electric) 40 is directly affixed to the top of said helmet 2 with the drive shaft of the stepper motor 40 vertical. The drive shaft of said stepper motor 40 replaces said pin 6 and turns said rod 12 directly. Said stepper motor 40 is affixed to the top of said helmet 2 by a stepper motor clip 42. A battery holder 44 is also affixed to the top of said helmet 2 with adhesive tab 46. The battery holder 44 may hold four AA batteries which are sufficient to power said stepper motor 40. A switch 48 and a stepper motor controller 50 are also affixed to said helmet 2. Said switch 48, said battery holder 44, said stepper motor 40, and said stepper motor controller 50 are connected by a circuit. Said stepper motor controller 50 is capable of controlling the speed, direction, duration, and the number of cycles. Said stepper motor controller 50 is, therefore, capable of controlling the speed of rotation of said rod 12 and said weight 14 as well as the direction of rotation and the duration of the rotation. Said stepper motor controller 50 is also capable of being programmed for a number of different cycles. For example, said weight 14 may be programmed to turn clockwise at seventy rotations per minute and then to switch to rotating counter-clockwise at sixty rotations per minute. This embodiment also shows an alternate method of connecting said rod 12 to said pin 6 (not shown in this embodiment) or to said stepper motor 40. A bushing 7 may be affixed to said pin 6 or said stepper motor 40 and said rod 12 being threaded to match a threaded hole in the bushing 7 and said rod 12 being screwed into said bushing 7.

In the preferred embodiment all elements are conventional with structural element being made from steel or plastic although other materials having similar properties could be used. All elements are conventional and may be purchase from a number of sources. Said stepper motor 40 (125 Oz-in) and said stepper motor controller 50 may be purchase from outlets such as Spakfun.com.

1. A neck exercise and rehabilitation device, comprising:
(1) headgear capable of being removaby affixed to a user's head;
(2) a generally vertical rod which is affixed to the top of the headgear and which is capable of being rotated about a vertical axis;
(3) a generally horizontal rod which is affixed at one end to the vertical rod near the top of said vertical rod, such that the horizontal rod is capable or rotating in a plane generally perpendicular to the axis of said vertical rod;
(4) a weight affixed to said horizontal rod at a point between the outer end of said horizontal rod and the point at which said horizontal rod is affixed to said vertical rod;
(5) an electric motor which is affixed to said helmet and is capable of being powered by plugging the electric motor into a conventional AC outlet;
(6) a controller connected to said electric motor capable of controlling the speed of said motor; and
(7) power transfer means connecting said electric motor to said vertical rod such that said electric motor may be used to rotate said vertical rod;
Whereby, a user my wear said headgear and use said electric motor to cause said vertical rod to rotate which causes said horizontal rod and said weight to rotate about a vertical axis.

2. The neck exercise and rehabilitation device of claim 1 in which said electric motor is battery powered rather than powered by a conventional AC outlet.

3. A neck exercise and rehabilitation device, comprising:
(1) headgear capable of being removably affixed to a user's head;
(2) an electric motor, said electric motor having a drive shaft, affixed to the top of the headgear such that the drive shaft of the electric motor is generally vertical and said electric motor is affixed near the top of said headgear;
(3) a rod which is affixed by one end to the drive shaft of the electric motor such that the rod rotates about the drive shaft of the electric motor in a generally horizontal plane; and
(4) electric means, such as four AA batteries, to power said electric motor.

4. The neck exercise and rehabilitation device of claim 2 in which a weight the weight is removably affixed to said rod at a point outward from said electric motor drive shaft.

5. The neck exercise and rehabilitation device of claim 3 in which a motor controller is added to allow control of the speed, direction, and duration of rotation of said electric motor.

6. The neck exercise and rehabilitation device of claim 4 in which a motor controller is added to allow control of the speed, direction, and duration of rotation of said electric motor.
